(19) United States
(12) Patent Application Publication
(10) Pub. No.: US 2016/0217433 A1
(43) Pub. Date: Jul. 28, 2016

(54) SYSTEM FOR AUTOMATED ASSET INSPECTION AND MAINTENANCE

(71) Applicants: Mark Adam Walton, Spring, TX (US); Eugene Thomas Johnson, Spring, TX (US)

(72) Inventors: Mark Adam Walton, Spring, TX (US); Eugene Thomas Johnson, Spring, TX (US)

(21) Appl. No.: 14/931,848

(22) Filed: Nov. 3, 2015

Related U.S. Application Data
(63) Continuation-in-part of application No. 14/657,198, filed on Mar. 13, 2015, now abandoned.
Application No. 14/657,198 is a continuation-in-part of application No. 14/657,231, filed on Mar. 13, 2015, now Pat. No. 9,305,407.
Application No. 14/657,231 is a continuation-in-part of application No. 14/855,371, filed on Sep. 15, 2015.
(60) Provisional application No. 62/109,029, filed on Jan. 28, 2015.

(51) Int. Cl. G06Q 10/00; G06F 3/0484; H04W 4/02; H04L 29/06

(52) U.S. Cl. CPC G06Q 10/20; H04L 63/08; G06F 3/0484; H04W 4/02

(57) ABSTRACT

A system for automated inspection and maintenance of an asset. The system can include at least one client device in communication with a mobile asset management module. The client device can receive inputs from a user or one or more sensors. The mobile asset management module can receive information from the client device to determine the identity of an asset, receive asset status information, analyze the asset status information, determine a status of the asset, determine a service requirement for the asset, and transmit the service requirement.

### CROSS REFERENCE TO RELATED APPLICATION

The current application is a Continuation in Part of co-pending application Ser. No. 14/855,371 filed Sep. 15, 2015, entitled “Conditional Proximity Based Equipment Authorization”, which is a Continuation in Part of co-pending application Ser. No. 14/657,198 filed Mar. 13, 2015, entitled “Fleet Management System”, and co-pending application Ser. No. 14/657,231 filed Mar. 13, 2015, entitled “Method for Fleet Management”, both of which claim priority to U.S. Provisional Patent Application Ser. No. 62/109,029 filed Jan. 28, 2015, entitled “Fleet Management System”. These references are incorporated herein in their entirety.

### FIELD

The present embodiments generally relate to a system for the inspection and maintenance of mobile assets.

### BACKGROUND

Many businesses have a need for, and retain significant numbers of physical assets required in the performance of their primary activities. Often these physical assets are in the form of multiple pieces of machinery with multiple authorized operators.

For assets such as construction equipment, specialized machinery, transport vehicles, and the like, numerous pieces of data must be tracked. Exemplary data includes information such as inspection records, maintenance needs and history, operator certification, regulatory data, and the like.

Often, fragmented systems and processes are employed for various business needs. Further, many businesses have difficulty in policing employees to verify that tasks have been properly accomplished, procedures have been properly followed, and documentation for both internal use or for regulatory compliance has been properly detailed.

A need exists for a system to streamline the process of asset inspection, asset maintenance, and proper documentation while simultaneously providing businesses with a means for ensuring that procedures are being properly followed by employees.

The present embodiments meet these needs.

### DETAILED DESCRIPTION OF THE EMBODIMENTS

Before explaining the present system in detail, it is to be understood that the system is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The present invention generally is a system for automated asset inspection, service, and maintenance. The invention is able to manage and track assets based upon business, regulatory, or other requirements. While it is contemplated that the invention is applicable to numerous industrial scenarios, exemplary descriptions will concentrate upon its application to a fleet of vehicles or similarly mobile assets.

The system comprises at least one client device in communication with a mobile asset management module. The client device can have a client processor, a client data storage, a client data transmitter, a client data receiver, and at least one sensor for detecting asset status information.

The client processor can be any electronic circuitry such as a processor or a microprocessor capable of carrying out the instructions of a computer program. The client data storage can be any computer readable medium capable of storing data in a non-transitory fashion. The data storage excludes any transitory signals but can include any non-transitory data storage circuitry, such as buffers, cache, and queues, within transceivers of transitory signals.

The client device can also have a client data transmitter and a client data receiver. In embodiments, the data transmitter and the data receiver can be a single device. The transmitter may communicate through a physical connection, or wirelessly such as by the use of radio waves, infrared communication, line of sight transmission, and the like.

The client device can also have at least one sensor for detecting information about an asset status. Exemplary client device sensors include, but are not limited to: a pedometer, a global positioning system sensor, a radio frequency receiver or transmitter, an infrared scanner, an interne receiver or transmitter, a camera, an accelerometer, an environmental sensor, a radar receiver or transmitter, a proximity sensor, a timer, a motion detector, and the like.

The client device can also have a plurality of computer instructions stored within the client data storage. These computer instructions can instruct the client processor to receive an input from a user, determine authorized actions for the user, receive data, and transmit data.

Input from a user can be in multiple forms, such as physical inputs such as typing, handwriting, motions of the client device, voice commands, and the like.

The client device can receive data from and transmit data to a mobile asset management module. The client device can also communicate with other systems as warranted by the specific application.

The mobile asset management module can be in communication with the client device.

The mobile asset management module can have a module processor, a module data storage, a module data transmitter, and a module data receiver.

The module processor can be any electronic circuitry such as a processor or a microprocessor capable of carrying out the instructions of a computer program. The module data storage can be any computer readable medium capable of storing data in a non-transitory fashion. The data storage excludes any transitory signals but can include any non-transitory data storage circuitry, such as buffers, cache, and queues, within transceivers of transitory signals.

The mobile asset management module can also have a module data transmitter and a module data receiver. In embodiments, the data transmitter and the data receiver can be a single device. The transmitter may communicate through a physical connection, or wirelessly such as by the use of radio waves, infrared communication, line of sight transmission, and the like.

The mobile asset management module can also have a plurality of computer instructions stored within the module data storage. These computer instructions can instruct the module processor to determine an identity of the asset, receive asset status information from the at least one client device, analyze asset status information from the at least one client device to form analyzed data, determine a status of the asset based upon the analyzed data, determine a service requirement of the asset based upon the analyzed data, and transmit the service requirement of the asset.

In embodiments, the mobile asset management module can have computer instructions instructing the module processor to display a procedure to the user, collect the asset status information based upon the procedure, log asset status information to form logged data, change the status of the asset based upon the service requirement of the asset, generate a work order based upon the service requirement of the asset and transmit the work order to the at least one client device, display or transmit the steps of a vehicle inspection or an equipment inspection, verify that the steps of the vehicle inspection or the equipment inspection are properly conducted by the user, determine an amount of time taken by the user to conduct the steps of the vehicle inspection or the equipment inspection, determine a distance traveled by the user to conduct the steps of the vehicle inspection or the equipment inspection, or respond to a triggering event.

The mobile asset management module can also communicate with the client device to determine a service requirement and optimized service timing and location for the asset. For example, a truck running low on fuel can be notified that a gas station with discounts for the specific trucking company is on route and accessible to the truck in one hour and another accessible in two hours. The mobile asset management module can determine the least disruptive service time and location based upon business rules. Various configurable rules can be used for this determination, such as distance until empty, discounts on fuel, smart-routing, hours of service for a driver, traffic patterns, and the like.

In embodiments, the triggering event can be an accident or an injury. For example, the client device can determine and communicate to the mobile asset management module that an accident has occurred. This can be because of information received from a sensor in communication with the client device, a sensor which is part of the client device, or a user input.

When an accident or a triggering event is detected, the mobile asset management module can determine if a drug or alcohol test is required. The requirement may be based upon business or regulatory needs, and the mobile asset management module can have access to a group of user configurable rules, or regulatory information. It can then determine the best location to send the driver or other worker, schedule the appointment, provide directions, confirm arrival, notify a concerned party and allow the driver or other worker to input results, receipts, confirmation or simply notify a concerned party upon completion or at any time before or after the testing has occurred.

The mobile asset management module can be configured to respond in a number of ways to a triggering event. Sensor information or a user input can be used to determine the identity and/or severity of a triggering event. The mobile asset management module can then specify a procedure based upon the identity and/or severity of a triggering event. For example, the mobile asset management module can provide instructions to a user for a procedure to be followed in the event of an accident. The procedure can include creating a report and notifying interested parties of the triggering event.

An exemplary use of the present embodiments with respect to a fleet of trucks is presented below to aid in understanding the invention. The invention is not intended to be limited to the following application.

A system for automated inspection and maintenance of an asset can be implemented to manage assets such as a fleet of trucks delivering cargo. The cargo can be delivered as a trailer attached to a tractor, or as various discrete shipments within a truck.

The system can have at least one client device comprising a client processor, a client data storage, a client data transmitter, a client data receiver, and a plurality of computer instructions stored within the client data storage instructing the client processor to receive an input from a user, determine authorized actions for the user, receive data, and transmit data.

The user can be a driver of a truck, a person who repairs or maintains the truck, a manager of the fleet of trucks, or any person requiring detailed and real time information about the trucks. In embodiments, a cellular phone or personal digital assistant can provide the necessary hardware for acting as a client device. Other devices specific to an application can also be implemented by persons having ordinary skill in the art.

The client device can have a number of login procedures specific to various users.

These procedures are well known to persons having ordinary skill in the art and need not be detailed herein. The client device can determine which user is presently providing input to the client device, and determine the authorized actions of the user.

For example, the client device may determine that a specific driver is not certified to drive the vehicle in question, and present a warning message that the driver is not authorized to operate the vehicle. The client device can also receive and transmit data, such as to the mobile asset management module discussed below.

The client device can receive input from the user, such as a driver or mechanic, be in communication with one or more sensors, or even comprise sensors for determining the truck status.

In embodiments, the client device can be used by a driver, can act as an inspection device, a service device, a mechanic device, and the like.

The system can have a mobile asset management module in communication with the one client device. The mobile asset management module can be a centralized computer in communication with the client device, or in other embodiments be attached to or stored within the client device.

Any device capable of performing the functions of a computer can be used as the mobile asset management module. The mobile asset management module comprises a module processor, a module data storage, a module data transmitter, and a module data receiver. In embodiments the module processor may be the same structure or device as the client processor.

The mobile asset management module can have a plurality of computer instructions stored within the module data storage, wherein the plurality of computer instructions comprises computer instructions instructing the module processor to determine an identity of the asset, receive asset status information from the at least one client device, analyze asset status information from the at least one client device to form analyzed data, determine a status of the asset based upon the analyzed data, determine a service requirement of the asset based upon the analyzed data, and transmit the service requirement of the asset.

Within the present example, the mobile asset management module can identify a specific truck from a fleet of trucks. Once the asset's identity has been determined, the mobile asset management module can receive a variety of asset status information from the client device.

Depending on the business needs of the specific application, the asset information may be user input, or received from one or more sensors either in communication with, or attached to the client device. Exemplary sensors include, but are not limited to: a pedometer, a global positioning system sensor, a radio frequency receiver or transmitter, an infrared scanner, an internet receiver or transmitter, a camera, an accelerometer, an environmental sensor, a radar receiver or transmitter, a proximity sensor, a timer, a motion detector, a pressure switch, a gyrometer, a radiation sensor, a chemical sensor, a carbon monoxide sensor, an oxygen sensor, an altimeter, a button, a touch pad, or a barometer.

For example, the mobile asset management module may receive information that the specific truck in question has a fuel tank that is twenty percent full. Using business logic that is configurable, the mobile asset management module can determine whether the fuel is sufficient for the route that the truck will take. If not, the mobile asset management module can determine the best place for the truck to be refueled based upon distance from route, traffic conditions, discounts offered by fuel stations, or any other pertinent logic.

The mobile asset management module can also determine a procedure or set of procedures that need to be followed for the truck. These procedures may be user specific, vehicle (or asset) specific, business specific, due to regulatory considerations, insurance requirements, and the like.

Upon determination of the procedure, the mobile asset management module can display the procedure to the user, and require the user to verify or attest that the procedure has been followed. The mobile asset management module can also be in communication with the client device and/or sensors to verify that the procedure has been followed.

For example, the truck may require a pre-trip inspection prior to being driven. The mobile asset management module can determine that this is the case and display to the driver a set of instructions or a procedure for a pre-trip inspection. The mobile asset management module can require the driver to input the result of each inspection step.

In embodiments, the mobile asset management module can be in communication with the client device to receive sensor information, such as determining a distance traveled by the driver to see if it meets a minimum required distance to walk around the vehicle. Other similar checks, such as using object recognition, pictures of inspected items, global positioning systems, time to complete procedures, or other sensors as described within this document can be used by the mobile asset management module to independently verify that procedures have been followed.

The mobile asset management module can use asset status information, either as provided by a user, or as gathered from a sensor to determine a status of the asset. Based upon asset status information received, the mobile asset management module can change the status of the asset. For example, the mobile asset management module may determine that the truck is not drivable because it needs repairs, requires certifications or other actions to comply with regulatory requirements, is not authorized for the user to drive, and the like.

The mobile asset management module can further determine necessary actions to be taken and generate and transmit work orders for repairs, service, and the like to a client device or other location. For example, if a pre-trip inspection turns up a defective part, the mobile asset management module can determine the necessary repairs, determine the best place or mechanic for conducting the repairs, and transmit a directive to the driver to deliver the vehicle to the mechanic, and transmit a work order to the mechanic authorizing the proper repairs.

In embodiments, the mobile asset management module may display procedures or information on the client device based upon a triggering event. The triggering event can be anything that the mobile asset management module receives information about. For example, accelerometer readings from the client device can indicate to the mobile asset management module that an accident has occurred. The mobile asset management module can then display an asset specific procedure to be followed in the event of an accident.

Items such as required documentation, witness statements, pictures, narratives, and the like can be received from the client device and logged by the mobile asset management module. In embodiments, the mobile asset management module can further transmit the information to regulatory agencies, insurance agencies, management, and the like. In embodiments, the mobile asset management module can further determine whether company policies or local regulations require a drug test and display instructions on where to complete such actions to the driver by determining the nearest available facility.

In some instances, tractor trailers may change trailers as well as load and offload cargo.

In these instances, the mobile asset management module can track the tractor and the trailer independently of one another. In embodiments, the cargo can be an asset that is managed by the mobile asset management module.

The present invention allows for the management and tracking of various assets, especially when multiple assets are mobile and have multiple users/operators.

While the present invention has been described with emphasis on the embodiments, it should be understood that within the scope of the appended claims, the embodiments might be practiced other than as specifically described herein by persons having ordinary skill in the art. Accordingly, the specification is intended to cover alternatives, modifications, and equivalents as may be included within the spirit and scope of the invention as defined in the following claims.

What is claimed is:

1. A system for automated inspection and maintenance of an asset comprising:
a) at least one client device comprising:
i) a client processor;
ii) a client data storage;
iii) a client data transmitter;
iv) a client data receiver;
v) a plurality of computer instructions stored within the client data storage instructing the client processor to:
1) receive an input from a user;
2) determine authorized actions for the user;
3) receive data; and
4) transmit data; and
b) a mobile asset management module in communication with the at least one client device, wherein the mobile asset management module comprises:
i) a module processor;
ii) a module data storage;
iii) a module data transmitter;
iv) a module data receiver;
v) a plurality of computer instructions stored within the module data storage, wherein the plurality of computer instructions comprises computer instructions instructing the module processor to:
1) determine an identity of the asset;
2) receive asset status information from the at least one client device;
3) analyze asset status information from the at least one client device to form analyzed data;
4) determine a status of the asset based upon the analyzed data;
5) determine a service requirement of the asset based upon the analyzed data; and
6) transmit the service requirement of the asset.

2. The system of claim 1, wherein the at least one client device further comprises at least one sensor for detecting asset status information or is in communication with a sensor for detecting asset status information.

3. The system of claim 1, wherein the asset is a vehicle or a piece of machinery.

4. The system of claim 1, wherein the at least one client device is an inspection device, a service device, or an inspection and a service device.

5. The system of claim 1, wherein the at least one sensor comprises:
a) a pedometer;
b) a global positioning system sensor;
c) a radio frequency receiver or transmitter;
d) an infrared scanner;
e) an internet receiver or transmitter;
f) a camera;
g) an accelerometer;
h) an environmental sensor;
i) a radar receiver or transmitter;
j) a proximity sensor;
k) a timer;
l) a motion detector;
m) a pressure switch;
n) a gyrometer;
o) a radiation sensor;
p) a chemical sensor;
q) a carbon monoxide sensor;
r) an oxygen sensor;
s) a button;
t) a touch screen;
u) an altimeter; or
v) a barometer.

6. The system of claim 1, wherein the plurality of computer instructions stored within the module data storage further comprises computer instructions instructing the module processor to:
a) determine which procedure to follow;
b) display a procedure to the user;
c) collect the asset status information based upon the procedure;
d) log asset status information to form logged data; or
e) change the status of the asset based upon the service requirement of the asset.

7. The system of claim 6, wherein the plurality of computer instructions stored within the module data storage further comprises computer instructions instructing the module processor to automatically generate a work order based upon the service requirement of the asset and transmit the work order to the at least one client device.

8. The system of claim 6, wherein the procedure comprises the steps of a vehicle inspection or an equipment inspection.

9. The system of claim 8, wherein the plurality of computer instructions stored within the module data storage further comprises computer instructions instructing the module processor to verify that the steps of the vehicle inspection or the equipment inspection are properly conducted by the user.

10. The system of claim 9, wherein the plurality of computer instructions stored within the module data storage further comprises computer instructions instructing the module processor to determine an amount of time taken by the user to conduct the steps of the vehicle inspection or the equipment inspection.

11. The system of claim 9, wherein the plurality of computer instructions stored within the module data storage further comprises computer instructions instructing the module processor to determine a distance traveled by the user to conduct the steps of the vehicle inspection or the equipment inspection.

12. The system of claim 6, wherein the procedure is displayed to the user based upon a triggering event.

13. The system of claim 12, wherein the triggering event is an accident or an injury.

14. The system of claim 6, wherein the plurality of computer instructions further comprises computer instructions instructing the module processor to transmit the logged data.

15. A system for automated tracking of a mobile asset comprising:
a) an asset sensor;
b) at least one client device comprising:
i) a client processor;
ii) a client data storage;
iii) a client data transmitter;
iv) a client data receiver; and
v) a plurality of computer instructions stored within the client data storage instructing the client processor to:
1) receive an input from the asset sensor;
2) determine a location of the asset;
3) receive data; and
4) transmit data.

16. A system for automated inspection and maintenance of a mobile asset comprising:
a) at least one client device comprising:
i) a client processor;
ii) a client data storage;
iii) a client data transmitter;
iv) a client data receiver;
v) at least one sensor for detecting asset status information;
vi) a plurality of computer instructions stored within the client data storage instructing the client processor to:
1) receive an input from a user;
2) determine authorized actions for the user;
3) receive data; and
4) transmit data; and
b) a mobile asset management module in communication with the at least one client device, wherein the mobile asset management module comprises:
i) a module processor;
ii) a module data storage;
iii) a module data transmitter;
iv) a module data receiver;
v) a plurality of computer instructions stored within the module data storage, wherein the plurality of computer instructions comprises computer instructions instructing the module processor to:
1) determine an identity of the asset;
2) receive asset status information from the at least one client device or a sensor in communication with the asset;
3) analyze asset status information from the at least one client device to form analyzed data;
4) determine a status of the asset based upon the analyzed data;
5) determine a service requirement of the asset based upon the analyzed data;
6) determine a service schedule for the asset based upon the analyzed data;
7) determine a service location for the asset based upon the analyzed data; and
8) transmit the service requirement of the asset.

17. The system of claim 13, wherein the mobile asset management module determines if a drug or alcohol test is required.

18. The system of claim 17, wherein the mobile asset management module determines the nearest drug or alcohol testing facility, compares that information to the preferred provider and in so determines which facility to send the worker for testing.

19. The system of claim 18, wherein the client device displays directions to the testing facility.

20. The system of claim 16, wherein the client device will alert another entity that an accident has occurred by one of:
a) short messaging service;
b) a push notification;
c) an email;
d) an instant message; or
e) an in application message.

21. The system of claim 16, wherein the client device will alert another entity that an injury has occurred by one of:
a) short messaging service;
b) a push notification;
c) an email;
d) an instant message; or
e) an in application message.

22. The system of claim 16, wherein an accident summary is created.

23. The system of claim 22, wherein either the mobile asset management module or the client device can contain computer instructions to, at the time of an accident or injury, instantly send the accident summary to one of:
a) an insurance agent;
b) a claims agent;
c) an insurance Company;
d) a manager;
e) a safety director;
f) a safety consultant;
g) a governmental entity;
h) a regulatory body; or
i) a concerned Party

24. The system of claim 16, wherein an accident summary includes at least one of:
a) a picture of the scene;
b) a picture of a vehicle involved in the accident;
c) a picture of a party involved in the accident;
d) a picture of cargo;
e) a picture of property damage;
f) a video recordings;
g) an audio recording;
h) information about a party involved in the accident; or
i) witness information

25. The system of claim 24, wherein a claim file is created using the accident summary.

26. The system of claim 25, wherein the claim file is stored in the module data storage.

27. The system of claim 16, wherein the triggering event can be detected by an accident sensor.

28. The system of claim 27, wherein the at least one accident sensor comprises:
a) an airbag deployment sensor;
b) an accelerometer;
c) a G-Force sensor or calculation as it relates to speed;
d) a gyrometer;
e) a crash sensor;
f) a speedometer; or
g) a compass

29. The system of claim 28, wherein the at least one accident sensor detects:
a) a change in speed;
b) a change in traveling direction;
c) a sudden shock;
d) a change in speed relative to time;
e) damage;
f) impact severity; or
g) an amount of damage to vehicle

30. The system of claim 29, wherein the mobile asset management module contains computer instructions to determine the severity of accident.

31. The system of claim 30, wherein the mobile asset management module contains computer instructions to determine the disposition of the vehicle.

32. The system of claim 31, wherein the mobile asset management module contains computer instructions to predict the cost of repair.

33. The system of claim 29, wherein the mobile asset management module contains computer instructions to determine the correct EMS to deploy to the scene.

34. The system of claim 18, wherein the client device transmits notice to the mobile asset management module that the worker has arrived at the drug testing facility.

35. The system of claim 14, wherein the asset is:
a) a cargo item;
b) a trailer;
c) a pallet;
d) a container;
e) a ship;
f) a vehicle;
g) an aircraft;
h) a spacecraft;
i) a box;
j) a package;
k) a fluid;
l) a gas;
m) a pollutant;
n) an animal; or
o) a human.

36. The system of claim 14, wherein the at least one client device determines an asset status.

37. The system of claim 14, wherein at least one client device determines an estimated time of arrival for the asset.

38. The system of claim 14, wherein at least one client device determines if the asset needs to be rerouted based on the estimated time of arrival for the asset.

39. The system of claim 14, wherein at least one client device determines estimated time of arrival for the asset based on:
a) traffic conditions;
b) fuel level;
c) required stops;
d) hours available for the driver to operate;
e) time of day;
f) weather conditions;
g) vehicle status; or
h) regulatory conditions.

40. The system of claim 14, wherein at least one client device transmits status updates to
a) the customer;
b) dispatch;
c) manager;
d) regulatory body;
e) third party consultant;
f) auditor;
g) tracking company;
h) shipper;
i) recipient;
j) warehouse; or
k) government entity

41. The system of claim 36, wherein the asset status is
a) ETA;
b) location;
c) association to a conveyance vehicle;
d) temperature;
e) securement of cargo;

42. The system of claim 14, wherein the asset sensor can
a) measure temperature;
b) determine if the doors are locked;
c) determine if the cargo is secure;
d) determine if the security of the cargo is breached;
e) determine spoilage;
f) transmit status of any measurement or determination;
g) transmit cargo identity;
h) transmit routing of cargo;
i) transmit primary destination;
j) transmit secondary destination;
k) transmit tertiary destination;
l) transmit exceptions;
m) transmit problem notifications;
n) transmit proximity; or
o) transmit an update.

43. The system of claim 14, wherein the at least one client device updates the cargo associated with the conveyance equipment automatically by receiving the cargo identifying information transmitted by the cargo sensor.

44. The system of claim 43, wherein the at least one client device transmits the updated status.
